(19) United States
(12) Patent Application Publication
(10) Pub. No.: US 2015/0097517 A1
(43) Pub. Date: Apr. 9, 2015

(54) BATTERY STRAP FOR ELECTRONIC DEVICE

(71) Applicant: Jeffrey James Stephenson, Sugarloaf, CA (US)

(72) Inventor: Jeffrey James Stephenson, Sugarloaf, CA (US)

(21) Appl. No.: 14/050,232

(22) Filed: Oct. 9, 2013

(51) Int. Cl. H01M 2/10; H02J 7/00

(52) U.S. Cl. CPC H01M 2/1005; H01M 2/1022; H02J 7/0042; H01M 2220/30
USPC 320/107; 429/98; 429/100

(57) ABSTRACT

Portable electronic devices comprise a housing having one or more straps attached thereto. The straps include battery cells disposed therein that are operatively connected to the housing. The straps comprise a construction material accommodating a number of the battery cells therein, wherein the battery cells are separated from one another to enable bending of the strap to facilitate wearing the device. The battery cells are operatively connected together in the strap by circuits, cables, or conduits. The straps include an attachment element configured to facilitate mechanically connecting the strap to the housing, which attachment element may also facilitate electrical connection with the housing. The straps may be releasibly attached to the housing to permit removal for recharging, or for replacement with charged straps. The straps may also include one or more accessories otherwise disposed in the housing for further reducing device packaging size.

### FIELD

Straps as disclosed herein are used for securing or wearing electronic devices and, more particularly, comprise a portable power supply used in conjunction with such electronic devices for powering the same.

### BACKGROUND

Devices such as portable electronic devices are known in the art, and are known to include one or more portable electronic power sources such as batteries disposed within the device itself. Such portable electronic devices include and are not limited to radios, phones, computers, watches, audio devices, video devices, combinations thereof, and the like. While the existing configuration of such devices comprising the portable battery source disposed within the device itself has been acceptable and conventional practice, as the desired size of the portable electronic devices have become smaller and smaller, and/or as the type of device itself and/or the location placement of the same during use has presented a practical packaging or spatial constraint for the componentry of such electrical devices, and/or the amount of features of such electronic portable devices has increased, it appears that a need exists for alternative componentry configurations and/or packaging configurations to address the same.

### SUMMARY

Portable electronic devices as disclosed herein comprise a housing that may include a user interface, and one or more straps attached to the housing. The straps comprise one or more portable power sources or battery cells disposed therein, wherein the power sources are operatively connected with the housing. The housing may include a display for presenting information to a user, wherein the display may also include a touch user interface.

The straps as used with the device comprises a construction material encasing or otherwise accommodating a number of the battery cell therein. In an example, the battery cells are separated from one another a distance sufficient to enable the strap to bend a desired amount to facilitate wearing the portable device by a user, e.g., around a portion of the user's body. In an example, the housing is configured to fit on a wrist of a user, and the device comprises a pair of straps that are configured to fit around and be worn on a user's wrist.

In an example, the battery cells are operatively connected together by electrically conductive circuits, cables, or conduits disposed within the strap. The straps include an attachment element configured to facilitate connecting the strap to the housing. In an example, the attachment element is configured to additionally electrically connect the battery cells in the straps with the housing. The attachment element is configured to releasibly attach with the housing to permit a user to attach and remove the strap from the housing, e.g., to remove the straps once discharged to facilitate strap recharging, or replacement of the straps with other straps having charged power sources, having a different style, and/or having one or more other features or accessories.

The straps as disclosed herein are configured to facilitate reducing the packaging size of the electronic device so to as to make wearing the device more practical and/or comfortable for the user. At the same time, such straps may be useful for accommodating other accessories in addition to the power source that would otherwise be disposed within the device housing, to thereby further facilitate reducing the packaging size of the portable device.

### BRIEF DESCRIPTION OF THE DRAWINGS

These and other features and advantages of devices as disclosed herein will be appreciated as the same becomes better understood by reference to the following detailed description when considered in connection with the accompanying drawings wherein:

FIG. 1 is a perspective view illustrating an example device as disclosed herein;

FIG. 2 is a close up view illustrating a section of the example device of FIG. 1;

FIGS. 3A and 3B are perspective views illustrating different views of example devices as disclosed herein; and

FIG. 4 is a perspective view illustrating an example charging device useful for charging the example device shown in FIG. 1.

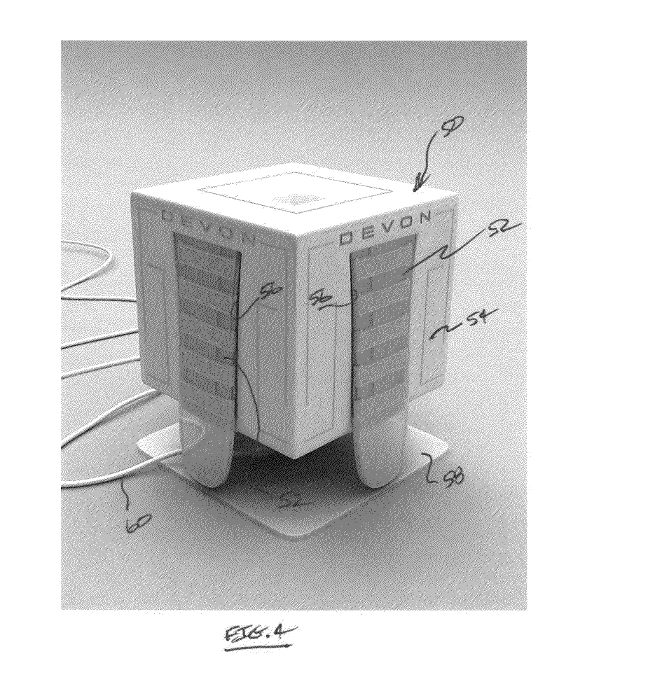

### DESCRIPTION

Devices as disclosed herein relate to portably-powered electrical devices and the packaging and configuration of the power sources useful for powering such electronic devices. In an example embodiment, the portably-powered electrical device can be one that is worn by a user, e.g., on a user's wrist, arm, leg, ankle, neck or the like. In such example of electrical devices that are worn by a user, it is sometimes desired that the packaging size of the device itself be optimized/minimized, e.g., for the purpose of wearable comfort and wearable practicality.

An example of such an electronic device, where packaging size presents an issue, is one that may be worn on a user's wrist. While battery-powered wrist watches are one example of such electronic devices, electronic devices constructed to provide more information than time can be configured to be worn on a user's wrist. Such a multifunctional electronic device can be one configured to provide operational features such as those provided by cellular phones, e.g., a smart phone, a tablet, a lap top computer, an audio and/or media player or the like. Such devices may comprise an external housing that is configured internally with the hardware and/or software necessary to perform desired functions.

As the functionality of such user wearable electronic device increases, so too does the size of the housing for the device to accommodate the necessary hardware, display, software, battery and the like to provide the desired user output and functionality. As the packaging size of the electronic device increases, this adversely impacts the practicality of comfortably or otherwise being able to wear the device.

Accordingly, electronic devices as disclose herein are provided comprising straps or bands that are specially configured to contain a portable power source and connect with (mechanically and electronically) a wearable electronic device to thereby reduce the packaging size of the electronic device (as the power source is no longer contained within the housing). In some embodiments, the device may still include a power source disposed within the housing and use it in conjunction with the straps as disclosed herein. However, it is anticipated in such instance that the power source disposed in the housing may be of a smaller size to achieve the desired objective of reducing the overall size of the housing to enhance wearable practicality.

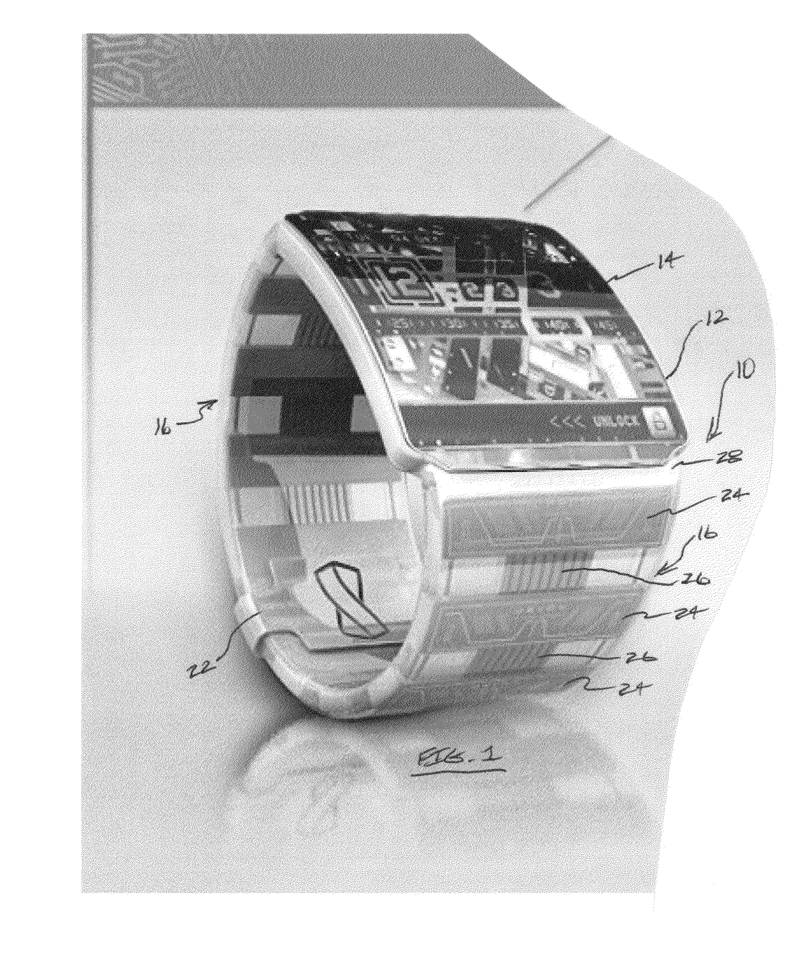

FIG. 1 illustrates an example electronic device 10 that is configured to be worn on a user's wrist. The device can be one that is configured to provide a number of different user functions using hardware and/or software and/or an operating system that is captive or that can be downloaded into the device. Accordingly, the particular function of the electronic device is not intended to be limited other than the fact that it is portably powered by a battery. In an example embodiment, the electronic device is a multi-functional device that includes electronic circuitry and a software-driven operating system, e.g., an Android operating system or the like, to perform a multitude of user desired functions. The electronic device may be configured to have additional user applications downloaded into it as desired. As noted above, while a wrist worn electronic device is provided by way of example it is to be understood that embodiments of the invention as disclosed herein are intended to be used with a number of differently configured and/or types of devices that may be worn or otherwise attached to a portion of a user other than a wrist, such as an ankle, arm, leg, neck, and the like, and that all such devices and uses are understood to be within the scope of the invention as disclosed herein.

In the example, the device 10 comprises a housing 12 with a display 14 positioned along a portion of the housing such as along a top surface of the housing. The display may comprise LED, LCD or other type of display technology, and may be user activatable by touch, e.g., in the form of a touch screen, or by other user interface provided by one or more user interface controls such as buttons or the like to enable the device to perform the desired functions provided by the user.

The device includes one or more straps or bands 16 that are attached to opposed ends 18 and 20 of the housing, and that are configured for placement around a user's wrist. A clasp or the like 22 may be used to secure the straps 16 together to provide a desired fitment around a user's wrist for wearing the electronic device. While the device disclosed and illustrated is provided in the form of a wrist-wearable electronic device, it is to be understood that straps as disclosed herein may be used with other types of electronic devices configured to be worn by a user around a portion of the user's body other than a user's wrist.

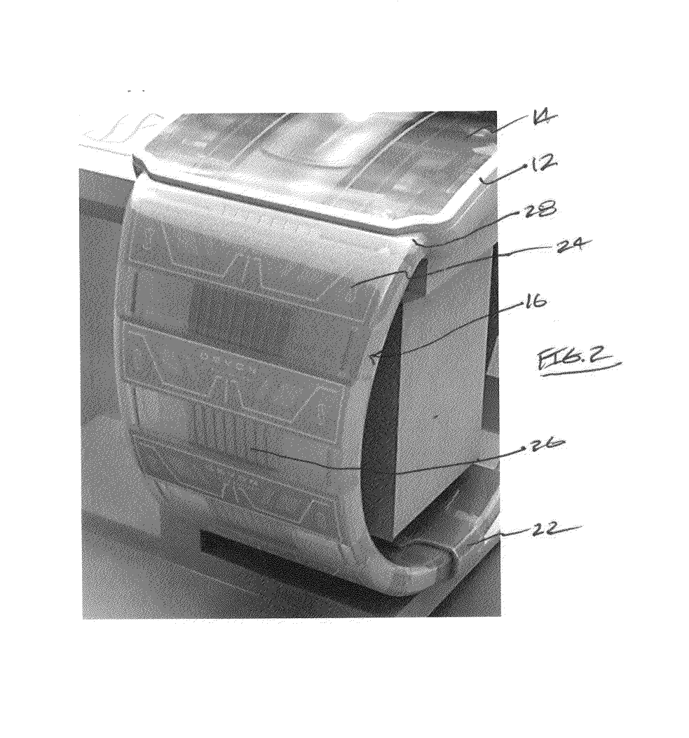

Referring to FIGS. 1 and 2, the straps 16 are configured comprising one or more battery cells 24 disposed therein. In an example embodiment, the straps 16 are configured comprising a number of battery cells 24 that are positioned at discrete positions along a length of the straps and that are electronically connected with one another to provide a desired battery voltage and current to power the electronic device. In an example embodiment, the straps comprise a number of cells 24 that each comprise a battery. In a preferred embodiment, the battery is a narrow lithium polymer battery. In an example embodiment, the straps comprise approximately 10 battery cells each and are configured to provide a voltage of approximately 3.6 volts to the housing to power the electronic device. In an example embodiment it is desired that the battery cells be of a narrow construction such that the thickness of the cells is from about 0.5 to 4 mm, 0.7 to 2_ mm, and preferably from about 0.8 to 1.2 mm. It is to be understood that the number of battery cells, the voltage of the combined cells and the thickness of the cells may vary from that disclosed above depending on the particular electronic device to be powered, and that such variation is intended to be within the scope of this disclosure.

It is to be understood that this is but one type of battery that can be used, and that types of battery technologies other than lithium polymer batteries can be used herein for the cells, and all such battery technologies are understood to be within the scope of this invention. Thus, it is to be understood that the exact number of cells contained within the straps can and will vary depending on the particular type of battery cells used as well as the power need for the particular type of electrical device.

In an example embodiment it is desired that the cells within the strap be configured in a manner so as to not cause discomfort or be oversized to the user, e.g., the cells be configured having a thin profile so as to reduce the thickness and/or bulk of the strap. Additionally, it is desired that the cells be configured and or numbered within the strap in a manner that enables a sufficient space to exist between the cells to provide a desired degree of flexibility to the strap to permit the strap to be bent around a user's wrist without damaging the strap, the cells and/or electrical circuitry within the strap, without causing cause user discomfort, and without adding to the bulk around a person's wrist (e.g., to enable the device to be worn underneath clothing or the like).

In this example, the cells 24 are separated from one another by a small gap of flexible strap material to allow the strap to bend and conform to provide a desired comfortable fit around a user's wrist. While each and every one of the cells need not necessarily be separated by one another (e.g., depending on the size of the particular cells), in order to provide a desired degree of flexibility it is desired that at least some of the cells be separated from one another a desired amount to provide such flexibility. In the example embodiment noted above (where the strap comprises approximately 10 cells that are sized having a thickness of 0.8 to 1.2 mm, it is desired that two or more of the cells be separated by about 1 to 10 mm, and preferably that each cell be separated from one another by about 3 to 5 mm.

The separate battery cells are electrically interconnected in parallel within the straps by proper circuitry and/or conduit 26, wherein the circuitry eventually is routed towards a connecting end 28 of the strap, i.e., an end of the strap that is connected to the device 12. As better described below, the straps are configured having an end 28 that mechanically attaches with the device, e.g., at a portion such as a lug or other mechanical structure and the like extending from the housing. In an example embodiment, where the device is as illustrated in FIGS. 1 and 2, each strap includes ends 28 that connect with respective lugs that extend from opposed ends of the housing to form a mechanical attachment therewith.

The straps 16 may be configured to be removably connected with the device 10, or may be irremovably connected with the device 10, depending on the particular device configuration and end-use application. In an example embodiment, the straps are configured to be removably connected with the device, e.g., to permit removal of the straps for charging, and/or to permit removal of the straps for replacement with straps of a different design, color, configuration, style, functionality, or the like. Configured in this manner, a user can have a number of pairs of straps for the purpose of both keeping a backup pair charged for quick and easy replacement (of a discharged set), and/or for the purpose of accessorizing the device (by pairing the device with differently styled straps).

In an example embodiment the straps may be configured to provide both a mechanical and an electrical connection with the device by the same mechanical attachment means disposed at the ends 28. Alternatively, the straps may be configured having a separate electrical attachment means for making an electrical connection with the device, e.g., via interconnecting electrical contacts, cables, leads, or the like. In a preferred embodiment, the straps are configured to provide both a mechanical and electrical connection using the same attachment element.

FIGS. 1 and 2 illustrate an example device 10 comprising straps 16 formed from a polymeric or plastic material. In such example, the polymeric material is used to provide a desired degree of strap flexibility while at the same time encasing the electrical components disposed or enclosed therein such as the battery cells and connecting circuitry and/or conduit. While a particular material of construction has been disclosed for forming the strap, it is to be understood that this is but one example and that other materials of construction can be used to form the strap. Other suitable materials include rubber, leather, metal and the like.

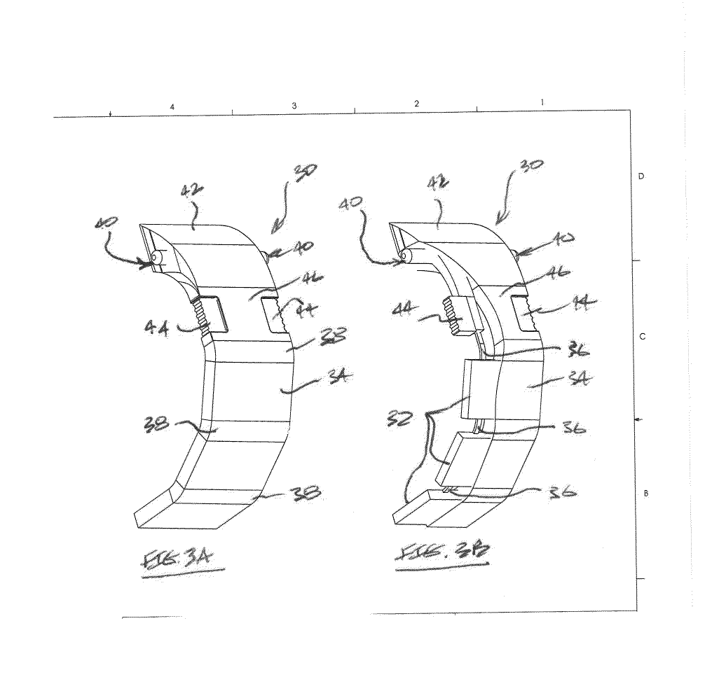

FIGS. 3A and 3B illustrate a section of another example strap 30, wherein the strap comprises a number of battery cells 32 disposed within a surrounding construction material 34, wherein the cells are electrically connected within the construction material by electrical circuitry, conduit or cable 36. In this example, the surrounding construction material 34 can be rubber, steel, plastic or a combination thereof. For example, the portion of the strap surrounding the each cell can be formed from a nonflexible material, such as metal or plastic, and interconnecting sections 38 of the strap between the cells can be formed from a flexible material such as a polymeric material, or rubber or the like to provide a desired degree of bending of the strap to facilitate placement and fit over a user's wrist.

The strap 30 includes an attachment means 40 in the form of posts that extend from opposed edge surfaces of the strap adjacent a strap end 42. In an example embodiment, the posts are configured to register and fit within respective complementary attachment members in the device to provide a mechanical attachment therewith. The posts 40 are connected within the strap 30 (as best illustrated in FIG. 3B) to activation elements 44 that extends from opposed end of an activation housing or link 46 in the strap. The activation elements 44 are configured to be releasable pressed together, e.g., between the fingers of a user, to cause the posts 42 to be retracted inwardly within the strap to thereby be refracted from the device for strap removal. In an example, the posts 42 are formed from a metallic material and are electrically connected with the electrical circuitry or cable 36 in the strap to thereby form an electrical connection with the device when attached thereto.

While a particular configuration of a strap and attachment means has been disclosed and illustrated in FIGS. 3A and 3B, it is to be understood that other configurations and/or or types of attachment elements, members or mechanisms for use in connecting (mechanically and/or electrically) the straps to the device can be used and are intended to be within the scope of the device as disclosed herein.

FIG. 5 illustrates a charger 50 that may be used in conjunction with the straps 52 as disclosed herein. In an example, the charger 50 comprises a housing 54 that is configured to provide electrical attachment with one or more straps to facilitate recharging of the straps. In an example, the housing has a square-shaped exterior surface, and includes a recessed section 56 in each of its four side faces for accommodating placement of a strap therein, for a total of four straps at a time. Each recessed section includes an electrical connection that attaches to the strap attachment elements or members for purposes of transmitting a desired charging current thereto, and may include hardware and/or software to facilitate changing the battery to a full state of charge and then shutting off the charger when such full state of charge is achieved.

The charger comprises a base 58 for placement on a supporting surface, and an electrical cord 60 for electrically connecting with an AC power source. The charger may comprise one or more compartments for storing additional straps not being charged. While a particular charger has been disclosed, it is to be understood that chargers configured other as described and illustrated are understood to be within the scope of use with devices as disclosed herein. Additionally, a charging device may be configured for accepting placement of the device itself, e.g., without the straps attached, thereto for the purpose of using the device while not being worn. In such an example the charging device is configured to provide a desired operating voltage directly to the device itself to support powering the device without or supplemental to the use of straps.

Portable-power supply straps as disclosed and illustrated herein have been used in conjunction with an electronic device wearable by a user on their wrist. Such a device can be a multifunctional device such as a smart watch or the like. As noted above, the device may comprise an MCU running an operating system, such as an Android system or the like, that permits a user to add and/or modify functions, operations and/or applications as desired to customize the device to best suit their needs. For example, the device can be configured for Bluetooth interconnectivity to interact with the user's smartphone, thereby allowing for text message and voice features to be used through the device, and allowing the user the latitude that comes with a free hand.

Additionally, the straps as disclosed herein in addition to containing a portable power source may be configured to include one or more accessories within various locations in the straps. For example, such accessories may be used to communicate data to the device via the attachment elements or via a separate connection element. Examples of such accessories include and are not limited to GPS, Bluetooth, Wi-Fi modules, Gyroscope and accelerometer modules, camera and microphone, memory modules and the like. Thus, a feature of straps as disclosed herein is that they can be used to accommodate accessories that would otherwise take up space within the device itself, thereby operating to further reduce the size of the device used in conjunction with the straps.

Although only a few example embodiments have been described in detail above, those skilled in the art will readily appreciate that many modifications are possible in the example embodiments without materially departing from this disclosure. For example, the straps as disclosed herein may be provided in the form of a pair of elements that both comprises the battery cells disposed therein, or wherein only one of the pair includes the cells. Also, straps configured to accommodate an accessory as disclosed above may or may not additionally include one or more battery cells, e.g., one of the pair may include the battery cells and the other of the pair may include the accessory.

Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112, paragraph 6 for any limitations of any of the claims herein, except for those in which the claim expressly uses the words ‘means for’ together with an associated function.

What is claimed is:

1. A portable electronic device comprising:
a housing comprising a user interface; and
a strap attached to the housing, wherein the strap comprises one or more portable power sources disposed therein, wherein the power sources are operatively connected with the housing.

2. The device as recited in claim 1 wherein the housing includes a display for presenting information to a user, and wherein the display comprises a touch user interface.

3. The device as recited in claim 1 wherein the strap comprises a construction material encasing a number of battery cells, and wherein the battery cells are separated by one another by a distance sufficient to enable the strap to bend a desired amount.

4. The device as recited in claim 3 wherein the strap is configured to be worn by a user.

5. The device as recited in claim 3 wherein the battery cells are operatively connected together by one or more electrically conductive cable disposed within the strap.

6. The device as recited in claim 1 wherein the housing is configured to fit on the wrist of a user, and the device comprises a pair of straps that are configured to fit around and be worn on a user's wrist.

7. The device as recited in claim 1 wherein the strap comprises an attachment element configured to facilitate connecting the strap to the housing.

8. The element as recited in claim 1 wherein the attachment element is configured to electrically connect the power sources with the housing

9. The device as recited in claim 1 wherein the attachment element is releasable to permit a user to attach and remove the strap from the housing.

10. The device as recited in claim 1 wherein the strap comprises one or more accessory used in conjunction with the device.

11. A portable electronic device comprising:
a housing comprising electrical circuitry; and
a pair of straps removably connected to the housing and configured to permit wearing of the device by a user, wherein one or both of the straps comprise a number of battery cells disposed within a strap construction material and electrically connected with one another, wherein the power sources are electrically connected with the housing to provide power thereto.

12. The device as recited in claim 11 comprising an operating system, a display, and a user interface.

13. The device as recited in claim 11 wherein the battery cells are separated from one another by a space sufficient to permit bending of the straps a desired degree to facilitate wearing of the device by a user.

14. The device as recited in claim 11 wherein the straps comprises an attachment element for connecting with the housing, wherein the attachment element is movable by a user from an attached position with the housing to a released position to facilitate removal of the strap from the housing.

15. The device as recited in claim 14 wherein the straps include a release mechanism that is connected with the attachment element for activation by a user to remove the straps from the housing.

16. The device as recited in claim 14 wherein the attachment element is electrically connected with the battery cells in the straps to provide an electrical connection with the housing to power the device.

17. The device as recited in claim 11 wherein the battery cells in the straps are rechargeable.

18. The device as recited in claim 11 wherein the strap comprises one or more accessory used in conjunction with the device.

19. A battery charger comprising an electrical attachment element for connecting with the straps as recited in claim 11 to recharge the battery cells.

20. A portable electronic device comprising:
a housing comprising electrical circuitry, a user interface, and a display all configured to provide one or more user desired output; and
one or more straps removably connected to the housing and configured to permit wearing of the device on a user's wrist, wherein the strap comprises a number of battery cells disposed within a strap construction material, and wherein the battery cells are electrically connected with one another, wherein the strap includes an attachment element for connecting the strap to the housing, and wherein the attachment element is connected with the battery cells in the strap to transmit electrical power to the housing to provide power thereto.

21. The device as recited in claim 20 wherein the battery cells are disposed along a length of the strap and are spaced apart from one another to enable the strap to bend a desired amount to facilitate placement and fitment on a user's wrist.

22. The device as recited in claim 20 wherein the strap includes a release mechanism that is connected with the attachment element for activation by a user to move the attachment element in a manner releasing the strap from the housing.

23. The device a recited in claim 20 wherein the battery cells are lithium polymer battery cells.

24. The device as recited in claim 20 wherein the strap comprises approximately 6 battery cells disposed therein.

25. A battery charger comprising a connection element for accommodating electrical contact with the strap as recited in claim 20, wherein the battery charger is configured to provide a charging current to the battery cells in the strap to recharge the battery cells disposed therein, wherein the electrical contact is made with the strap attachment element.
